(19) United States
(12) Patent Application Publication
(10) Pub. No.: US 2016/0161304 A1
(43) Pub. Date: Jun. 9, 2016

(54) FAULT DIAGNOSIS METHOD FOR RESOLVER

(71) Applicants: Hyundai Motor Company, Seoul (KR); Kia Motors Corporation, Seoul (KR)

(72) Inventors: Gi Bong Son, Hwaseong (KR); Hye Seung Choi, Gunpo (KR); Won Kyoung Choi, Hwaseong (KR); Heon Young Kwak, Hwaseong (KR)

(21) Appl. No.: 14/923,735

(22) Filed: Oct. 27, 2015

(30) Foreign Application Priority Data
Dec. 3, 2014 (KR) 10-2014-0171899

(51) Int. Cl. G01D 15/00; G01D 3/08; G01D 5/20

(52) U.S. Cl. CPC G01D 15/00; G01D 5/20; G01D 3/08

(57) ABSTRACT

The present disclosure provides a fault diagnosis method for a resolver including: receiving output signals for detecting an absolute angular position of a rotor of a motor, inputted from the resolver when the motor rotates in a state in which excitation signals are applied to the resolver; periodically sampling and reading voltage values for fault diagnosis from the received output signals inputted as voltage signals from the resolver; calculating a difference between voltage values of two output signals of the received output signals generating an angle detection signal for detecting the absolute angular position of the rotor; and determining a short circuit between an excitation signal and an output signal of the resolver by comparing the difference between the voltage values with a preset setting voltage.

### CROSS-REFERENCE TO RELATED APPLICATION

This application claims under 35 U.S.C. §119(a) the benefit of and priority to Korean Patent Application No. 10-2014-0171899 filed Dec. 3, 2014, the entire contents of which are incorporated herein by reference.

### BACKGROUND

(a) Technical Field

The present disclosure relates generally to a fault diagnosis method for a resolver. More particularly, it relates to a method capable of exactly diagnosing a fault of a resolver for detecting an absolute angular position of a rotor of a motor.

(b) Background Art

In recent years, studies on eco-friendly vehicles, such as pure electric vehicles (EVs), hybrid electric vehicles (HEVs) and fuel cell electric vehicles (FCEVs), which can be substituted for existing internal-combustion engine vehicles, have been actively conducted due to high oil prices, regulations of carbon dioxide emissions, and the like. In these eco-friendly vehicles, an electric motor (i.e., traction motor) is used as a traction source. The electric motor is frequently a permanent magnet synchronous motor, particularly an interior permanent magnet synchronous motor, which has characteristics of high power and high efficiency.

In addition, an inverter system for driving and controlling the motor is installed in the vehicle, and a resolver is used as a position sensor for detecting an absolute angular position (θ) of a rotor of the motor, which is used to control the motor. In general, the resolver includes a stator, a rotor, and a rotary transformer. Coils of the stator and the rotor are wound so that their magnetic flux distributions become sinusoidal waves with respect to angles.

If first and second input signals (Rez+ and Rez− as excitation signals) are applied to a primary-side coil (i.e., input stage), and a rotating shaft (rotor) is rotated, the magnetic coupling coefficient of the coil is changed, so that signals each having a carrier of which amplitude is changed are generated in a secondary-side coil (i.e., output stage). In this case, the coils are wound so that the signals have sine (sin) and cosine (cos) forms according to rotation angles of the rotating shaft. Thus, the signals generated in the secondary-side coil as described above are output signals (i.e., voltage signals) S1 to S4 output through the output stage of the resolver, and the output signal has the form of a sine (sin) or cosine (cos) signal.

Meanwhile, in order to perform vector control of an electric motor used in an eco-friendly vehicle, the coordinate system should be set in synchronization with the magnetic flux position of the electric motor. To this end, it is necessary to read an absolute angular position of a rotor of the electric motor. Accordingly, a resolver is used to detect the absolute angular position.

Each phase of the rotor is exactly sensed using the resolver, so that it is possible to perform motor speed control and torque control, required in EVs, HEVs and FCEVs. As such, the role of a resolver is further increased in terms of control of an electric motor. However, if the exact position of a motor drive system cannot be measured due to a wiring mismatch of the resolver, it is impossible to perform a function of correcting an offset of the motor, or the like. Therefore, the driving environment of a vehicle deteriorates. Particularly, if a fault occurs in the resolver due to a short circuit of the resolver, it is impossible to detect a fault of the motor. In addition, there may even occur a situation in which driving the vehicle becomes impossible. Accordingly, it is important to develop a technique capable of exactly diagnosing a fault such as a short circuit occurring in a resolver.

As shown in FIG. 1, a resolver 10 includes an input stage 101 to which a first input signal (positive excitation signal Rez+) and a second input signal (negative excitation signal Rez−) are input as excitation signals 201; a first output stage 102 configured to output first and third output signals S1 and S3 constituting a sine signal generated from the excitation signals 201; and a second output stage 103 configured to output second and fourth output signals S2 and S4 constituting a cosine signal generated from the excitation signals 201. The first output signal S1 is a signal output from a (+) terminal of the first output stage 102, and the third output signal S3 is a signal output from a (−) terminal of the first output stage 102. The second output signal S2 is a signal output from a (+) terminal of the second output stage 103, and the fourth output signal S4 is a signal output from a (−) terminal of the second output stage 103.

A general controller 200 configured to perform fault diagnosis of the resolver 100, and motor control includes a central processing unit (CPU) and a resolver-to-digital converter (RDC) connected to the CPU. In the controller 200, a fault signal is generated through the RDC, and as the fault signal generated in the RDC is input to the CPU, it is possible to determining a fault of the resolver 100.

Hereinafter, a conventional fault diagnosis method for a resolver used as a position sensor of a motor in an eco-friendly vehicle will be described as follows. First, a fault of a resolver is diagnosed using voltage signals output from a resolver, i.e., output signals S1, S2, S3 and S4. If any one of output signals S1, S2, S3 and S4 is short-circuited with an excitation signal in the rotation of a motor, as shown in FIG. 2, the short-circuited output signal has a constant voltage value, and the other signals swing in a state in which their polarity is their polarities are reversed with respect to that of the short-circuited output signal.

In this state, the fault of the resolver is determined by comparing the voltage value of the output signal with setting voltages set to (+) and (−) diagnosis levels. Here, the (+) and (−) setting voltages are determined as a value between an output signal in a normal state and an output signal in a short-circuit state.

If the voltage value of the output signal exists out of the diagnosis levels, i.e., if the voltage value of the output signal is beyond the range between the (+) and (−) setting voltages, it is determined that a short circuit between the excitation signal and the output signal has occurred. However, in the conventional diagnosis method described above, the margin between the voltage in the normal state and the voltage in the short-circuit state is small, and the output signal is sensitive to a variation of the excitation signal, caused by component tolerance of the resolver and temperature. Therefore, it is highly likely that an erroneous diagnosis will be made.

### SUMMARY OF THE DISCLOSURE

The present disclosure provides a fault diagnosis method for a resolver to detect a short circuit between an excitation signal and an output signal of the resolver, which can prevent an erroneous diagnosis caused by sensitiveness to a variation of the excitation signal, and improve the accuracy of diagnosis as a large margin exists between a voltage in a normal state and a voltage in a short-circuit state.

According to embodiments of the present disclosure, a fault diagnosis method for a resolver includes: receiving output signals for detecting an absolute angular position of a rotor of a motor, inputted from the resolver when the motor rotates in a state in which excitation signals are applied to the resolver; periodically sampling and reading voltage values for fault diagnosis from the received output signals inputted as voltage signals from the resolver; calculating a difference between voltage values of two output signals of the received output signals generating an angle detection signal for detecting the absolute angular position of the rotor; and determining a short circuit between an excitation signal and an output signal of the resolver by comparing the difference between the voltage values with a preset setting voltage.

The two output signals generating the angle detection signal may be a pair of output signals for generating an angle detection signal in the form of a sine signal.

The two output signals generating the angle detection signal may be a pair of output signals for generating an angle detection signal in the form of a cosine signal.

The two output signals generating the angle detection signal may be a pair of output signals generating an angle detection signal in the form of a sine signal and another pair of output signals generating an angle detection signal in the form of a cosine signal. A difference between voltage values of the pair of output signals may be compared with the setting voltage, and a difference between voltage values of the other pair of output signals may be compared with the setting voltage.

The setting value may be configured with a (+) setting value set as a positive value and a (−) setting value set as a negative value.

The method may further include determining that a short circuit between an excitation signal and an output signal has occurred when the difference between the voltage values of the two output signals is greater than the (+) setting value or less than the (−) setting value.

The method may further include determining that a short circuit between a positive excitation signal and an output signal of the resolver has occurred when the difference between the voltage values of the two output signals is a positive value and greater than the (+) setting value.

The method may further include determining that a short circuit between a negative excitation signal and an output signal of the resolver has occurred when the difference between the voltage values of the two output signals is a negative value and smaller than the (−) setting value.

The periodic sampling and reading of the voltage values for fault diagnosis may include sampling the voltage values for fault diagnosis while having a time difference corresponding to a phase difference of 180 degrees between the two output signals generating the angle detection signal.

The method may further include generating a pulse signal using, as a pulse width, the time difference corresponding to the phase difference of 180 degrees. A voltage value of one of the two output signals may be read as a voltage value for fault diagnosis at a time corresponding to a rising edge of the pulse signal every pulse period, and a voltage value of the other of the two output signals may be read as a voltage value for fault diagnosis at a time corresponding to a falling edge of the pulse signal every pulse period.

The method may further include reading a maximum value of the output signal in each sampling period is read as a voltage value for fault diagnosis.

Furthermore, according to embodiments of the present disclosure, a non-transitory computer readable medium containing program instructions for performing a fault diagnosis method for a resolver, the computer readable medium includes: program instructions that receive output signals for detecting an absolute angular position of a rotor of a motor, inputted from the resolver when the motor rotates in a state in which excitation signals are applied to the resolver; program instructions that periodically sample and read voltage values for fault diagnosis from the received output signals inputted as voltage signals from the resolver; program instructions that calculate a difference between voltage values of two output signals of the received output signals generating an angle detection signal for detecting the absolute angular position of the rotor; and program instructions that determine a short circuit between an excitation signal and an output signal of the resolver by comparing the difference between the voltage values with a preset setting voltage.

According to the above-described fault diagnosis method for a resolver, fault diagnosis is performed using a difference between pair signals output from the resolver, so that a large margin occurs between a voltage in a normal state and a voltage in a fault (i.e., short-circuit) state. Thus, it is possible to prevent an erroneous diagnosis caused by the fluctuation of an excitation signal, etc. and to clearly distinguish the normal state from the fault state, thereby improving the accuracy of diagnosis.

The above and other features of the disclosure are discussed infra.

### BRIEF DESCRIPTION OF THE DRAWINGS

The above and other features of the present disclosure will now be described in detail with reference to certain embodiments thereof illustrated the accompanying drawings which are given hereinbelow by way of illustration only, and thus are not limitative of the present disclosure, and wherein:

FIG. 1 is a block diagram illustrating a resolver for detecting a position of a rotor of a motor and a controller for performing fault diagnosis;

FIG. 2 is a diagram illustrating a conventional fault diagnosis method for a resolver;

FIG. 3 is a diagram illustrating a fault diagnosis method for a resolver according to embodiments of the present disclosure;

FIG. 4 is a diagram illustrating a sampling method of a signal value for fault diagnosis in the fault diagnosis method according to embodiments of the present disclosure;

FIG. 5 is a flowchart illustrating a fault diagnosis process for a resolver according to embodiments of the present disclosure; and

FIG. 6 is a diagram illustrating test results obtained by allowing excitation signals and output signals to be short-circuited while rotating a motor.

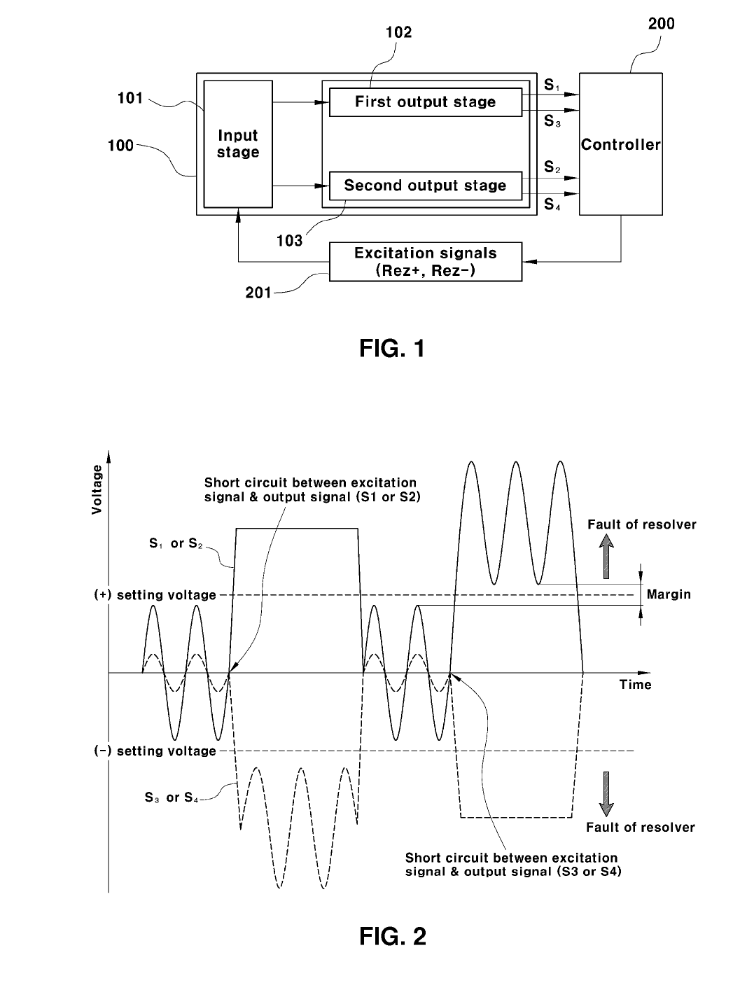

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment. In the figures, reference numbers refer to the same or equivalent parts of the present disclosure throughout the several figures of the drawing.

### DETAILED DESCRIPTION OF THE EMBODIMENTS

Hereinafter reference will now be made in detail to various embodiments of the present disclosure, examples of which are illustrated in the accompanying drawings and described below. While the disclosure will be described in conjunction with embodiments, it will be understood that present description is not intended to limit the disclosure to those embodiments. On the contrary, the disclosure is intended to cover not only the embodiments, but also various alternatives, modifications, equivalents and other embodiments, which may be included within the spirit and scope of the disclosure as defined by the appended claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Furthermore, the controller of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

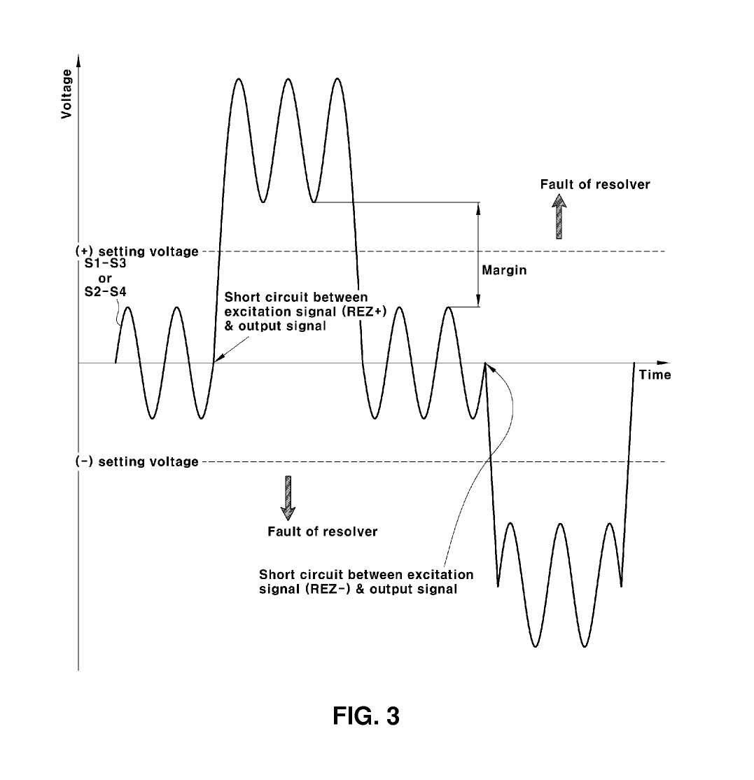

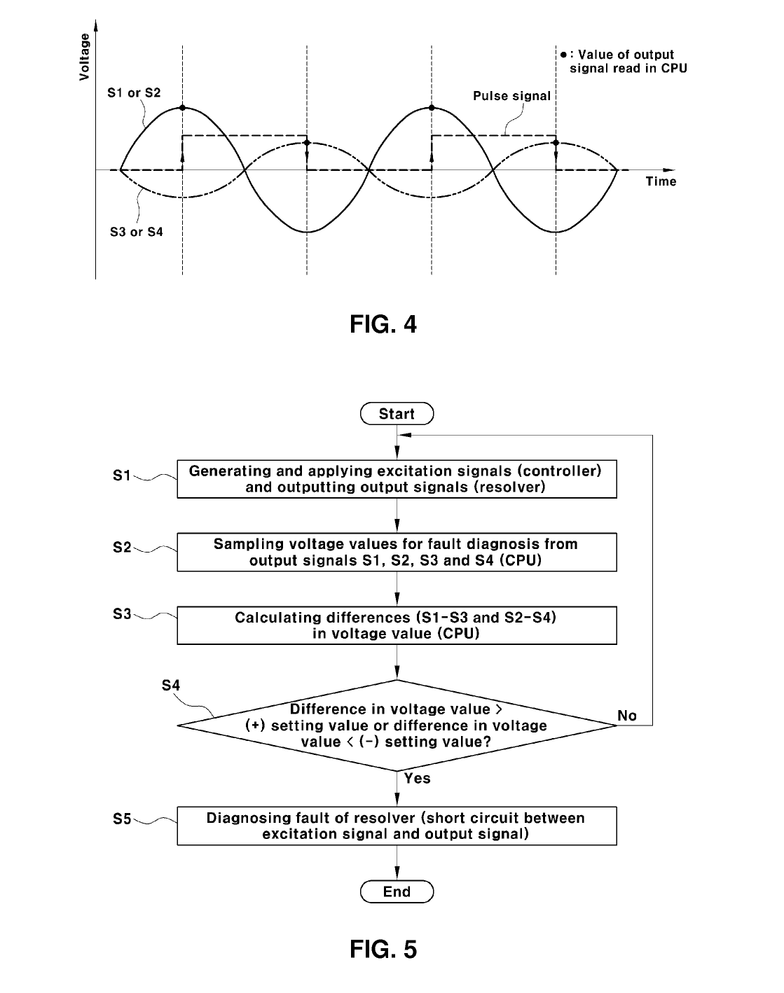

Referring now to the disclosed embodiments, FIG. 3 is a diagram illustrating a fault diagnosis method for a resolver according to embodiments of the present disclosure. FIG. 4 is a diagram illustrating a sampling method of a signal value for fault diagnosis in the fault diagnosis method according to embodiments of the present disclosure.

As shown in FIG. 3, when a positive excitation signal (REZ+) is short-circuited with any one of output signals S1, S2, S3 and S4, a difference between a pair of output signals (i.e., voltage signals) for generating one angle detection signal and a difference between another pair of output signals (i.e., voltage signals) for generating another angle detection signal are considerably increased as compared with those in a normal state of the resolver, thereby having (+) values. When a negative excitation signal (REZ−) is short-circuited with any one of the output signals S1, S2, S3 and S4, a difference between a pair of output signals (i.e., voltage signals) for generating one angle detection signal and a difference between another pair of output signals (i.e., voltage signals) for generating another angle detection signal are considerably decreased as compared with those in the normal state of the resolver, thereby having (−) values.

As known in the art, two angle detection signals are required so that the absolute angular position of a rotor of a motor is evaluated from output signals of a resolver during rotation of the motor. One of the two angle detection signals is a sine signal, and the other of the two angle detection signals is a cosine signal. Generally, a resolver includes a stator mounted inside a housing, and a rotor installed inside the stator. The resolver has one input stage to which AC voltages are input as excitation signals (REZ+ and REZ−), a first output stage outputting a sine signal (first and third output signals, i.e., signals S1 and S3) according to a rotational position of the rotor, and a second output stage outputting a cosine signal (second and fourth signals, i.e., signals S2 and S4).

According to a resolver configured as described above, in a state in which an AC voltage is applied to a stator configured by winding a primary-side coil through the input stage of the resolver, if the rotor of the resolver is rotated as a rotor of a motor rotates, a carrier frequency in the form of a sinusoidal wave amplitude-modulated by changing the magnetic coupling coefficient of the coil between the stator and the rotor is output as a sine signal through the first output stage, and a carrier frequency in the form of a sinusoidal wave amplitude-modulated by changing the magnetic coupling coefficient of the coil between the stator and the rotor is output as a cosine signal through the second output stage. That is, by excitation signals input to the input stage, the first output stage outputs first and third signals S1 and S3 for generating an angle detection signal in the form of a sine (sin) signal, and the second output stage outputs second and fourth signals S2 and S4 for generating an detection signal in the form of a cosine (cos) signal.

Here, the first and third output signals S1 and S3 become a pair of output signals constituting an angle detection signal in the form of a sine signal, and the second and fourth output signals S2 and S4 become another pair of output signals constituting an angle detection signal in the form of a cosine signal. Accordingly, the absolute angular position (θ) of the rotor of the motor can be detected using a phase change between the sine signal that the pair of output signals S1 and S3 constitute and the cosine signal that the pair of output signals S2 and S4 constitute.

Therefore, when the positive excitation signal (REZ+) is short-circuited with any one of the output signals, the level of a difference in voltage between the output signals S1 and S3 for generating one angle detection signal and the level of a difference in voltage between the output signals S2 and S4 for generating another angle detection signal are considerably increased as compared with those in the normal state of the resolver, thereby having (+) values. Meanwhile, when the negative excitation signal (REZ−) is short-circuited with any one of the output signals, the level of a difference in voltage between the output signals S1 and S3 for generating one angle detection signal and the level of a difference in voltage between the output signals S2 and S4 for generating another angle detection signal are considerably decreased as compared with those in the normal state of the resolver, thereby having (−) values. As such, the values of the differences (i.e., S1-S3 or S2-S4) in voltage between the two pairs of output signals in the short-circuit state of the resolver are considerably different from those in the normal state of the resolver. In this state, a margin between the voltage in the normal state and the voltage in the short-circuit state (i.e., when comparing the difference in voltage between a pair of output signals in the normal state with that in the short-circuit state) has a value much greater than that (i.e., when comparing the difference in voltage between a pair of output signals in the normal state with that in the short-circuit state) in the conventional fault diagnosis process.

In consideration of the above, in the present disclosure, a voltage value of each of the output signals S1, S2, S3 and S4 is periodically sampled, and differences (i.e., S1-S3 and S2-S4) in voltage between the two pairs of output signals for generating angle detection signals (i.e., sine and cosine signals) are then evaluated, thereby comparing the differences with preset (+) and (−) setting voltages.

As described above, in the case where the differences (S1-S3 and S2-S4) in voltage between the two pairs of output signals are used, the values of the differences in the normal state are considerably different from those in the short-circuit state, and the margin between the voltage in the normal state and the voltage in the short-circuit state is remarkably increased as compared with that in the conventional art. Thus, the problem of erroneous diagnosis can be solved in the present disclosure in which the value of a difference in voltage between two output signals are compared with a setting voltage, as compared with the conventional art in which the value of one output signal (i.e., the value of a stage signal) is compared with a setting value.

Particularly, in a case where a fault of the resolver is diagnosed using the value of a difference between two output signals, the resolver is further strong against component tolerance such as tolerance occurring in a signal generation circuit device of the resolver and operating condition such as temperature, and the margin between voltages of the two output signals is remarkably increased as compared with that in the conventional art. Thus, the level in the normal state can be clearly distinguished from that in the short-circuit state.

In the present disclosure, a fault of the resolver is determined by comparing the value of a difference in voltage between two output signals with setting voltages previously set to (+) and (−) diagnosis levels in the rotation of the motor. Here, the (+) and (−) setting voltages are previously defined as values between the difference in voltage between the two output signals in the normal state and the difference in voltage between the two output signals in the short-circuit state.

If the difference in voltage between the two output signals exists out of the diagnosis levels, i.e., if the difference in voltage between the two output signals is beyond the range between the (+) and (−) setting voltages, it is determined that a short circuit has occurred between an excitation signal and an output signal.

Meanwhile, the fault diagnosis of the present disclosure can be performed in a software manner in a central processing unit (CPU) by using the output signals (voltage signals) 51, S2, S3 and S4 without using any hardware such as a resolver-to-digital converter (RDC). In this regard, a sampling process of periodically extracting a voltage value for fault diagnosis from each of the output signals S1, S2, S3 and S4. A method of sampling a value of an output signal for fault diagnosis in the CPU will be described as follows.

First, the two output signals S1 and S3 or S2 and S4 for generating one angle detection signal in the resolver have a phase difference of 180 degrees. In order to evaluate a typical absolute angular position of the rotor, values of each output signal are sampled at the same time. On the other hand, in the fault diagnosis process of the present disclosure, the CPU receives output signals S1, S2, S3 and S4 output from the resolver to periodically sample pair signals, i.e., values of an output signal for fault diagnosis with respect to each pair of output signals S1 and S3 or S2 and S4 while having a time difference corresponding to the phase difference of 180 degrees between the two output signals.

FIG. 4 shows a pair of output signals for generating one angle detection signal, and illustrates a method of sampling a value of an output signal for fault diagnosis from the pair of output signals.

The pair of output signals shown in this figure may be the first and third output signals S1 and S3 output in the form of a sine signal, or the second and fourth output signals S2 and S4 output in the form of a cosine signal. As shown in this figure, in order to extract a signal value (i.e., voltage value) for fault diagnosis from each output signals, the CPU reads signal values for fault diagnosis from two output signals of the resolver while having a time difference corresponding to the phase of 180 degrees between the two output signals. The CPU periodically repeats the extraction of values for fault diagnosis.

In this instance, the CPU samples signal values for fault diagnosis in a software manner by generating a pulse signal using, as a pulse width, the time difference corresponding to 180 degrees and reading voltage values of each output signal at times corresponding to rising and falling edges of each pulse period. That is, the pulse signal is used as a signal for setting times at which the values for fault diagnosis with respect to each output signal are sampled. A voltage value of the output signal S1 (or S2) is sampled at a rising edge of the pulse signal, and a voltage value of the output signal S3 (or S4) is sampled at a falling edge of the pulse signal. Preferably, as shown in FIG. 4, the pulse signal is generated so that the sampling values of the two output signals can become maximum values in one sampling period.

FIG. 5 is a flowchart illustrating a fault diagnosis process for a resolver according to embodiments of the present disclosure. The fault diagnosis process will be described step by step with reference to FIG. 5.

First, if a controller generates excitation signals and applies the excitation signals to an input stage in the rotation of a motor, each output stage of the resolver outputs output signals in the form of sine and cosine signals (S1).

The output signals S1, S2, S3 and S4 output from output stages of the resolver as described above are input to a CPU for the purpose of fault diagnosis. The CPU periodically samples a voltage value for fault diagnosis with respect to each pair signal, i.e., each pair of output signals S1 and S3 or S2 and S4 by using the sampling method described above (S2).

The CPU calculates a difference between voltage values of the two output signals, obtained for each sampling period (S3), and compares the difference between the voltage values with (+) and (−) setting voltages (S4).

FIG. 4 shows output signals of the resolver, output in the normal state. However, if there occurs a short circuit between an excitation signal and an output signal, the polarities of two voltage values for fault diagnosis, sampled from the pair of output signals S1 and S3 or S2 and S4, become opposite to each other.

As shown in FIG. 3, in the case where there occurs a short circuit between the positive excitation signal (REZ+) and an output signal, the difference between voltage values for fault diagnosis becomes a positive value exceeding the (+) setting voltage ((+) diagnosis level). In the case where there occurs a short circuit between the negative excitation signal (REZ−) and an output signal, the difference between voltage values for fault diagnosis becomes a negative value smaller than the (−) setting voltage ((−) diagnosis level).

Accordingly, the CPU determines that a fault of the resolver has occurred when the difference between two voltage values for fault diagnosis, sampled from the output signal S1 (i.e., first output signal) and the output signal S3 (i.e., third output signal), or the difference between two voltage values for fault diagnosis, sampled from the output signal S2 (i.e., second output signal) and the output signal S4 (i.e., fourth output signal), is greater than the (+) setting voltage or smaller than the (−) setting value (S5).

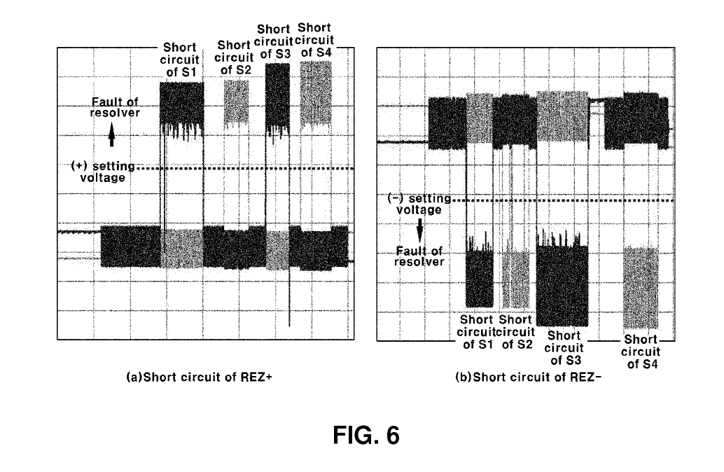

FIG. 6 is a diagram illustrating test results obtained by allowing excitation signals and output signals to be short-circuited while rotating a motor. As shown in (a) of FIG. 6, it can be seen that when the positive excitation signal (REZ+) is sequentially short-circuited with the output signals S1, S2, S3 and S4, differences between voltages of the output signals are all greater than the (+) setting voltage.

When the output signal S1 or S3 is short-circuited with the positive excitation signal (REZ+), the voltage value with respect to the pair of output signals S1 and S3 exceeds the (+) setting value. When the output signal S2 or S4 is short-circuited with the positive excitation signal (REZ+), the voltage value with respect to the pair of output signals S2 and S4 exceeds the (+) setting value.

As shown in (b) of FIG. 6, it can be seen that when the negative excitation signal (REZ−) is sequentially short-circuited with the output signals S1, S2, S3 and S4, differences between voltages of the output signals are all smaller than the (−) setting voltage. When the output signal S1 or S3 is short-circuited with the negative excitation signal (REZ−), the voltage value with respect to the pair of output signals S1 and S3 is smaller than the (−) setting value. When the output signal S2 or S4 is short-circuited with the negative excitation signal (REZ−), the voltage value with respect to the pair of output signals S2 and S4 exceeds the (−) setting value.

Accordingly, as can be seen in FIG. 6, the voltage level in the normal state is considerably different from that in the short-circuit state, in differences between voltage values of the two output signals. Thus, it is possible to clearly diagnose a fault (i.e., a short circuit between an excitation signal and an output signal) of the resolver.

The disclosure has been described in detail with reference to embodiments thereof. However, it will be appreciated by those skilled in the art that changes may be made in these embodiments without departing from the principles and spirit of the disclosure, the scope of which is defined in the appended claims and their equivalents.

What is claimed is:

1. A fault diagnosis method for a resolver, comprising:
receiving output signals for detecting an absolute angular position of a rotor of a motor, inputted from the resolver when the motor rotates in a state in which excitation signals are applied to the resolver;
periodically sampling and reading voltage values for fault diagnosis from the received output signals inputted as voltage signals from the resolver;
calculating a difference between voltage values of two output signals of the received output signals generating an angle detection signal for detecting the absolute angular position of the rotor; and
determining a short circuit between an excitation signal and an output signal of the resolver by comparing the difference between the voltage values with a preset setting voltage.

2. The fault diagnosis method of claim 1, wherein the two output signals generating the angle detection signal are a pair of output signals for generating an angle detection signal in the form of a sine signal.

3. The fault diagnosis method of claim 1, wherein the two output signals generating the angle detection signal are a pair of output signals for generating an angle detection signal in the form of a cosine signal.

4. The fault diagnosis method of claim 1, wherein the two output signals generating the angle detection signal are a pair of output signals generating an angle detection signal in the form of a sine signal and another pair of output signals generating an angle detection signal in the form of a cosine signal, and
wherein a difference between voltage values of the pair of output signals is compared with the setting voltage, and a difference between voltage values of the other pair of output signals is compared with the setting voltage.

5. The fault diagnosis method of claim 1, wherein the setting value is configured with a (+) setting value set as a positive value and a (−) setting value set as a negative value.

6. The fault diagnosis method of claim 5, further comprising:
determining that a short circuit between an excitation signal and an output signal has occurred when the difference between the voltage values of the two output signals is greater than the (+) setting value or less than the (−) setting value.

7. The fault diagnosis method of claim 6, further comprising:
determining that a short circuit between a positive excitation signal and an output signal of the resolver has occurred when the difference between the voltage values of the two output signals is a positive value and greater than the (+) setting value.

8. The fault diagnosis method of claim 6, further comprising:
determining that a short circuit between a negative excitation signal and an output signal of the resolver has occurred when the difference between the voltage values of the two output signals is a negative value and smaller than the (−) setting value.

9. The fault diagnosis method of claim 1, wherein the periodic sampling and reading of the voltage values for fault diagnosis comprises:
sampling the voltage values for fault diagnosis while having a time difference corresponding to a phase difference of 180 degrees between the two output signals generating the angle detection signal.

10. The fault diagnosis method of claim 9, further comprising:
generating a pulse signal using, as a pulse width, the time difference corresponding to the phase difference of 180 degrees,
wherein a voltage value of one of the two output signals is read as a voltage value for fault diagnosis at a time corresponding to a rising edge of the pulse signal every pulse period, and a voltage value of the other of the two output signals is read as a voltage value for fault diagnosis at a time corresponding to a falling edge of the pulse signal every pulse period.

11. The fault diagnosis method of claim 9, further comprising:
reading a maximum value of the output signal in each sampling period is read as a voltage value for fault diagnosis.

12. A non-transitory computer readable medium containing program instructions for performing a fault diagnosis method for a resolver, the computer readable medium comprising:
program instructions that receive output signals for detecting an absolute angular position of a rotor of a motor, inputted from the resolver when the motor rotates in a state in which excitation signals are applied to the resolver;
program instructions that periodically sample and read voltage values for fault diagnosis from the received output signals inputted as voltage signals from the resolver;
program instructions that calculate a difference between voltage values of two output signals of the received output signals generating an angle detection signal for detecting the absolute angular position of the rotor; and
program instructions that determine a short circuit between an excitation signal and an output signal of the resolver by comparing the difference between the voltage values with a preset setting voltage.
